(19) United States
(12) Patent Application Publication
(10) Pub. No.: US 2016/0368586 A1
(43) Pub. Date: Dec. 22, 2016

(54) PRODUCTION METHOD FOR PRODUCING A LOAD-BEARING FUSELAGE PANEL AND FUSELAGE PANEL PRODUCIBLE THEREWITH

(71) Applicant: AIRBUS DEFENCE AND SPACE GMBH, Taufkirchen (DE)

(72) Inventors: Christian Weimer, Munich (DE); Rainer Rauh, Jetzendorf (DE)

(21) Appl. No.: 15/186,121

(22) Filed: Jun. 17, 2016

Related U.S. Application Data
(63) Continuation of application No. PCT/DE2014/000601, filed on Nov. 26, 2014.

(30) Foreign Application Priority Data
Dec. 18, 2013 (DE) 10 2013 021 066.6

(51) Int. Cl. B64C 1/12; B64F 5/00; B64C 1/06

(52) U.S. Cl. CPC B64C 1/12; B64C 1/068; B64C 1/066; B64F 5/0009; B64C 2001/0072

(57) ABSTRACT

In order to simplify a system integration in a fuselage of an aircraft, the disclosure herein provides a production method for producing a load-bearing fuselage panel for a fuselage section of an aircraft fuselage in an area of an aircraft cabin, including manufacturing the fuselage panel to have a sandwich construction with an inner panel and an outer skin as shells and a filling panel embedded between the shells as a core, while configuring the outer skin as a part of a fuselage structure and the outer delimitation of the aircraft fuselage, configuring the inner panel for an interior space delimitation of the cabin, and integrating functional elements of the fuselage structure and the cabin and/or the aircraft into the filling panel. Preferably, the shells and the filling panel are connected to each other by a joining process while producing covalent bonds.

### CROSS-REFERENCE TO RELATED APPLICATIONS

This application is a continuation of and claims priority to PCT/DE2014/000601 filed Nov. 26, 2014, which claims the benefit of and priority to German patent application No. 10 2013 021 066.6, filed Dec. 18, 2013, the entire disclosures of which are incorporated by reference herein.

### TECHNICAL FIELD

The disclosure herein relates to a production method for producing a load-bearing fuselage panel for a fuselage section of an aircraft fuselage in the area of an aircraft cabin. Further, the disclosure herein relates to a load-bearing fuselage panel for forming a fuselage section as a part of a load-bearing structure of an aircraft fuselage in the area of an aircraft cabin.

### BACKGROUND

So far, aircraft, such as commercial aircraft in particular, are developed, devised and produced in such a way that first, the load-bearing fuselage structure is devised and produced by an aircraft producer, and then, the cabin is designed depending on the requirements of the commercial aircraft and fitted into the fuselage structure. Accordingly, the structural airplane fuselage and the cabin including its covering elements towards the structure of the airplane fuselage are today manufactured separately by the large aircraft manufacturers, such as Airbus. The integration of systems, such as flight systems, entertainment systems, climate systems, control systems, also takes place as a separate process step between the structure fabrication and the cabin integration. Though this concept has proved itself with respect to the variability of the cabins and the possible application purposes provided in this manner, it results in a high degree of fabrication complexity.

With respect to the prior art regarding the configuration of fuselage structures for aircraft, reference is made, for example, to DE 10 2010 013 370 A1, EP 2 411 280 B1 and to Herbeck/Kindervater: Ein neues Designkonzept für einen CFK-Flugzeugrumpf; Werkstoffkolloquium 2006; Wettbewerb der Werkstoffe; DLR Werkstoffkolloquium 2006.

### SUMMARY

It is an object of the disclosure herein to reduce the complexity of designing and producing an aircraft fuselage, to save weight and to optimize the production of an airplane fuselage.

In order to achieve this object, the disclosure herein proposes a production method for producing a load-bearing fuselage panel and a corresponding fuselage panel.

Advantageous embodiments of the disclosure are disclosed herein and are, for example and at least in part, the subject matter of the dependent claims.

According to a first aspect, the disclosure herein provides a production method for producing a load-bearing fuselage panel for a fuselage section of an aircraft fuselage in an area of an aircraft cabin, including: Fabricating the fuselage panel to have a sandwich construction with an inner panel and an outer skin as shells and a filling panel embedded between the shells as a core while configuring the outer skin as a part of a fuselage structure and the outer delimitation of the aircraft fuselage, configuring the inner panel for an interior space delimitation of the cabin and integrating functional elements of the fuselage structure and the cabin or the aircraft into the filling panel.

A preferred embodiment of the production method comprises steps a) to f), wherein the designation of the steps with a) to f) or with additional numbers in the entire present disclosure including the claims is selected only for easier reference and does not make any statements regarding a certain order of the steps:

a) Designing and fabricating the filling panel in such a way that it is configured for accommodating functional elements of the fuselage structure and of the cabin and/or of the aircraft;
b) Providing the filling panel with functional elements of the fuselage structure and/or of the cabin and/or of the aircraft;
c) Fabricating the outer skin as a shell of the fuselage panel;
d) Fabricating the inner panel as a shell of the fuselage panel;
e) Attaching the filling panel to one of the shells, and
f) Attaching the other shell to the filling panel.

Preferably, at least two of the steps a), c) and/or d) are carried out so as to overlap at least partially in time, and/or in parallel.

Preferably, step a) includes the step of:

a1) Pre-assembling the filling panel.

Preferably, step a) includes the step of:

a2) Fabricating the filling panel from composite material or composite materials.

Preferably, step a) includes the step of:

a3) Fabricating the filling panel from profiled elements made from a flat material and filler material.

Preferably, step a) includes the step of:

a4) Providing the filling panel with a core material, in particular with a structural foam.

Preferably, step a) includes the step of:

a5) Providing the filling panel with protrusions and cavities.

Preferably, step a) includes the step of:

a6) Providing the filling panel with join surfaces, which are prepared for a substance-to-substance connection to at least one of the shells.

Preferably, step a) includes at least one of the steps of:

a7.1) Fabricating the filling panel by RTM technology, or
a7.2) Fabricating the filling panel to have a fully thermoplastic composite construction.

Preferably, step a) includes the step of:

a8) Fabricating the filling panel with omega profiles with a foam portion.

Preferably, step b) includes the step of:

b1) Pre-mounting at least one functional element of the fuselage structure and/or of the cabin into the filling panel prior to carrying out the steps e) and f).

Preferably, step b) includes the step of:

b2) Inserting at least one functional element of the fuselage structure and/or of the cabin into the filling panel attached to the one fuselage component between the steps e) and f).

Preferably, step b) includes the step of:

b3) Providing the filling panel, during the fabrication according to step a), with webs, formers, ribs and/or joints as functional elements for the load-bearing configuration of the fuselage structure.

Preferably, step b) includes the step of:

b4) Incorporation of at least one system component of a cabin system, a flight system and/or a fuselage structure system as a functional element into at least one cavity of the filling element.

Preferably, step b) includes the step of:

b5) Inserting at least one functional element into at least one cavity of the filling element and filling the cavity with an insulating material and/or covering the cavity with a shell within the context of carrying out at least one of the steps e) and f).

Preferably, step c) includes the step of:

c1) Fabricating the outer skin from a metal material.

Preferably, step c) includes the step of:

c2) Fabricating the outer skin from a composite material. Particularly preferably, the outer skin is fabricated from, or using, a fiber composite material, such as CFRP, for instance.

Preferably, step c) includes the step of:

c3) Fabricating the outer skin with a lightning protection device.

For further details regarding possible lightning protection devices, reference is made to DE 10 2011 112 518 A1 or DE 10 2006 046 002 A1.

Preferably, step c) includes the step of:

c4) Fabricating the outer skin in such a way that requirements for the protection against damage of the aircraft are satisfied. This can be done, for example, by equipping the outer skin with a damage, stress and/or fatigue monitoring device, or by separate fabrication of the structure of the outer skin in accordance with the location of use, e.g. by a force flow-adapted fiber orientation of fibers of a fiber composite structure, by using tailored blanks with corresponding variable thicknesses, etc.

For further details regarding an optional damage, stress and/or fatigue monitoring device, express reference is made to WO 2012/010496, WO 2012/055699 A1, DE 10 2008 003 498 A1 and WO 2009/071602 A2.

Preferably, step c) includes the step of:

c5) Providing the outer skin with at least one positioning aid for positioning the filling panel on the outer skin.

Preferably, step d) includes the step of:

d1) Fabricating the inner panel with predetermined fire protection properties. In particular, the inner panel can be fabricated in a fire protection configuration, e.g. by a corresponding choice of material, by additionally providing fire protection materials or the like. The fact that the inner panel, due to the integration of functional elements into the filling panel, can be configured with correspondingly fewer through-holes or breaks, which would otherwise possibly require special fire protection measures—such as a fire wall, for example—is particularly advantageous.

Preferably, step d) includes the step of:

d2) Fabricating the inner panel in such a manner that fire protection requirements of the cabin are met.

Preferably, step d) includes the step of:

d3) Fabricating the inner panel in such a manner that it is suitable as an outer closure of the cabin towards the fuselage structure.

Preferably, step d) includes the step of:

d4) Fabricating the inner panel with at least one positioning aid for the relative positioning between the inner panel and the filling panel while carrying out the corresponding one of the steps e) or f).

Preferably, step e) includes the step of:

e1) Relative positioning of the filling panel and the one shell by positioning aids prefabricated on the one shell.

Preferably, step e) includes the step of:

e2) Connecting the filling panel to the one shell by substance-to-substance connection.

Preferably, step e) includes the step of:

e3) Connecting the filling panel to the one shell by producing covalent bonds. Preferably, a connection which produces covalent bonds, e.g. a TP-to-TP diffusion bonding, is used in a joining process.

Preferably, step e) includes the step of:

e4) Arranging the filling panel with open cavities, so that an open sandwich structure for inserting functional elements into the filling panel is created.

Preferably, step e) includes the step of:

e5) Gluing the filling panel to the one shell at prepared join surfaces of the filling panel.

Preferably, step e) includes the step of:

e6) Detachably connecting the filling panel to the one shell.

Preferably, step e) includes the step of:

e7) Detachably attaching the filling panel to the one shell by a functional layer.

Preferably, step e) includes the step of:

e8) Detachably attaching the filling panel to the one shell by an adhesive that dissolves under a dissolving treatment—such as heating, for example.

Preferably, step e) includes the step of:

e9) Attaching the filling panel at first only to the outer skin.

Preferably, step f) includes the step of:

f1) Relative positioning of the filling panel and the other shell by positioning aids prefabricated on the other shell.

Preferably, step f) includes the step of:

f2) Connecting the filling panel to the other shell by substance-to-substance connection.

Preferably, step f) includes the step of:

f3) Connecting the filling panel to the other shell by producing covalent bonds. Preferably, a connection which produces covalent bonds, e.g. a TP-to-TP diffusion bonding, is used in a joining process.

Preferably, step f) includes the step of:

f4) Gluing the filling panel to the other shell at prepared join surfaces of the filling panel.

Preferably, step f) includes the step of:

f5) Detachably connecting the filling panel to the other shell.

Preferably, step f) includes the step of:

f6) Detachably attaching the filling panel to the other shell by another functional layer.

Preferably, step f) includes the step of:

f7) Detachably attaching the filling panel to the other shell by an adhesive that dissolves under a dissolving treatment.

Preferably, step f) includes the step of:

f8) Attaching the inner panel to the filling element after the filling element has first been attached to the outer skin.

Preferably, step f) includes the step of:

f9) Sealing an open sandwich structure formed by cavities of the filling panel after at least one functional element has been introduced into the cavity.

According to another aspect, the disclosure herein provides a load-bearing fuselage panel for forming a fuselage section as a part of a load-bearing structure of an aircraft fuselage in the area of an aircraft cabin, wherein the fuselage panel is formed to have a sandwich construction with an inner panel and an outer skin as shells and a filling panel embedded between the shells as a core, wherein the outer skin is configured as a part of a fuselage structure and the outer delimitation of the aircraft fuselage, wherein the inner panel is configured for an interior space delimitation of the cabin, and wherein functional elements of the fuselage structure and the cabin or the aircraft are integrated into the filling panel.

In particular, such a fuselage panel is produced by carrying out the production method of the disclosure herein or one of the advantageous embodiments thereof, or is configured so as to have the same properties and features of a fuselage panel produced with the method according to the disclosure herein or the advantageous embodiments thereof.

According to another aspect, the disclosure herein provides an aircraft fuselage or an aircraft cabin comprising such a fuselage panel.

Special advantages of preferred embodiments of the disclosure herein are explained in more detail below.

In the traditional fabrication of airplane fuselages and their cabins, the structural airplane fuselage and the cabin including its covering elements towards the structure are manufactured separately. System integration also takes place as a separate process step between the structure fabrication and cabin integration. In contrast to this traditional mode of development and fabrication, the disclosure herein makes it possible to already integrate functional elements of the cabin or functional elements of the load-bearing structure or also functional elements of other systems of the aircraft during the fabrication of the load-bearing structure, and to transfer cabin fabrication into an overall concept.

So far, individual functional capabilities were respectively integrated into the fuselage structure; however, an embodiment into a comprehensive overall concept for fuselage fabrication including cabin integration and system integration is not provided for a comprehensive functional integration.

In a particularly preferred embodiment of the production method, the functional integration takes place during the manufacture of a load-bearing sandwich structure for an aircraft fuselage, such as, in particular, an aircraft fuselage. For example, the cabin requirements, system installations and the outer skin fabrication are integrated into a joint development and manufacturing concept already during the development of the sandwich structure for the aircraft fuselage.

Thus, a load-bearing fuselage panel is created which immediately fulfils the function of the cabin, e.g. fire protection properties, system installation and maintainability of the systems as well as the structural properties of the outer skin including the integration of lightning protection or other requirements for the outer skin.

The extension of the construction—taking cabin requirements into consideration already during the fuselage fabrication, or taking the requirements of the load-bearing structure into consideration during cabin fabrication—may also result in the possibility of incorporating crash elements into the structure.

Preferably, the concept enables simple, section-by-section modifications and repairs which will reduce the long life costs of an aircraft and increase recycling capabilities.

Weight additionally introduced into the fuselage, which is introduced by the traditional, separate observation of the individual working processes, is avoided by a possible utilization of function-integrated material systems already in the construction concept and in the fabrication concept.

For example, significant savings with regard to weight and costs can be achieved by a reduction of rivet and screw connections and a transfer into adhesive connections or the like.

The structural concept of an overall integration of the fabrication of the fuselage structure and cabin elements can simplify and integrate working processes of system integration, and thus, costs can be saved in fabrication.

### BRIEF DESCRIPTION OF THE DRAWINGS

An exemplary embodiment of the disclosure herein will be explained below with reference to the drawings. In the drawings:

FIG. 1 shows a sectional view through a load-bearing fuselage panel with a sandwich construction for constructing a fuselage panel forming a part of an outer cabin wall and, at the same time, a part of a load-bearing fuselage structure;

FIG. 2 shows a view, which is comparable to FIG. 1, of a precursor during the fabrication of the fuselage panel of FIG. 1.

### DETAILED DESCRIPTION

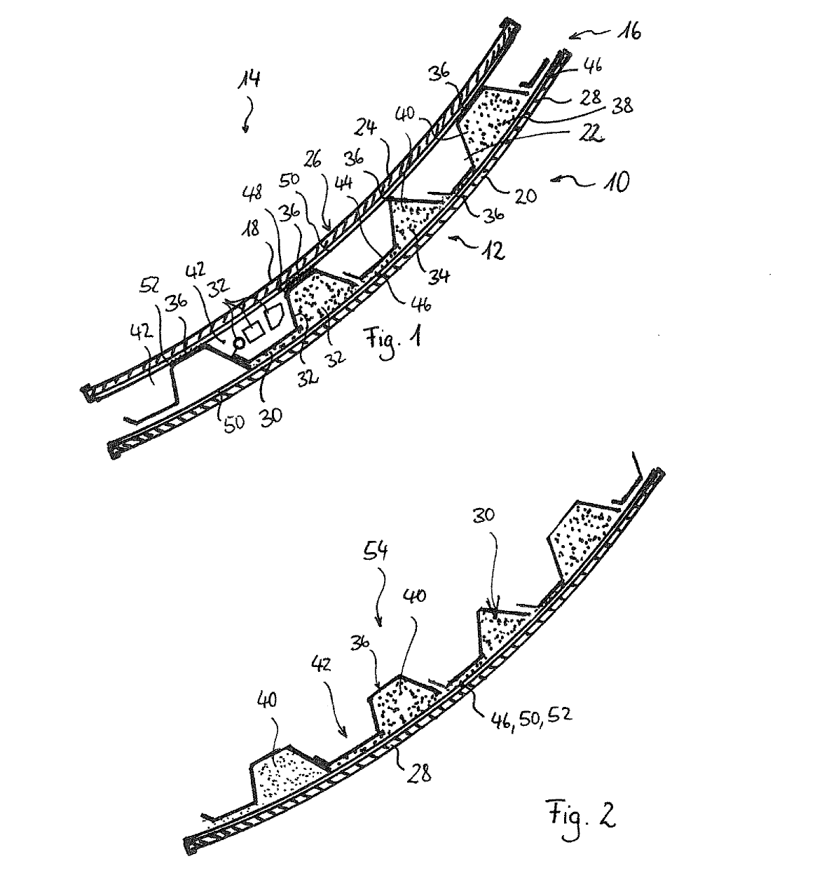

FIG. 1 shows a fuselage panel 10 for forming a part of a load-bearing fuselage structure 12 and an outer wall of a cabin 14 of an aircraft, such as, for example, an airplane. The fuselage panel 10 is formed to have a sandwich construction or as a sandwich element 16 with an inner shell 18, an outer shell 20 and a core 22 between them.

The inner shell 18 is formed by an inner panel 24 that serves for forming an interior space delimitation 26 of the cabin 14.

The outer shell 20 is formed by an outer skin 28 that serves for forming a part of the fuselage structure 12 and of the outer delimitation of the aircraft fuselage.

The core 22 is formed by a filling panel 30 into which functional elements 32 of the fuselage structure 12, the cabin 14 or of another system of the aircraft are integrated.

Accordingly, the fuselage panel 10 is substantially formed from three core elements, in principle. The outer skin 28 and the inner panel 24 form the shells 18, 20. The two shells 18, 20 are connected to each other by an assembly process, with the pre-assembled filling panels 30 being used in the process.

These pre-assembled filling panels 30 are formed, for example, in a composite construction, such as from CFRP materials, for example, and contain a core material 34 and prepared join surfaces 36 for connecting the filling panel 30 to the shells 18, 20.

The join surfaces are configured in such a way that a material connection on a polymer level takes place during the fusion of the components.

The filling panel 30 can be manufactured by an RTM technique. “RTM” stands for Resin Transfer Molding. Resin Transfer Molding is a method for producing molded articles from thermosetting materials and/or elastomers. In contrast to pressing, the molding material is injected, by pistons or similar injection devices, from a (most frequently heated) prechamber via distribution channels into a mold cavity, where it hardens under heat and pressure.

In particular by an RTM technique, the production of the filling panels 30 can also take place in large numbers, so that high fuselage production rates can also be obtained. Using the RTM method, it is also possible to produce the corresponding interfaces for adapting the join surfaces 36.

For example, an integrally formed filling panel 30 can be formed by an RTM process from an integrated structural foam 38, which is capable of transmitting forces and loads in the hardened state.

Of course, the production of the filling panels 30 can also take place in another manner, such as, for example, by a fully thermoplastic composite construction.

In particular, the functional element 32 is configured with protrusions 40 having join surfaces 36 at the end faces thereof and cavities 42 between them.

The cavities 42 can serve for accommodating the functional elements 32 and can be filled with insulating material (not shown) when producing a system installation.

The material of the structural foam 38 used may also have insulating properties.

Such a construction makes it possible
a) to configure the inner panel in such a manner that fire protection requirements of the cabin 14 of an aircraft are met;
b) to configure the outer skin 28 in such a way that lightning protection and damage protection requirements of an aircraft are met; and
c) to fabricate the filling panels 30 in a pre-assembled manner in such a way that they support system functions.

Since the filling panels 30 can be fabricated in a separate process, different configurations may occur.

In addition to the structural foam 38, profiled elements 44 are also indicated in the illustrated exemplary embodiment, which also take on load-bearing tasks.

In particular, the fuselage loads can be transmitted by the structural foam 38 and/or profiled elements 44—possibly in combination with formers to be inserted.

For example, omega profiles with a foam portion or even simple ribs can partially occur in the filling panel 30. Joints may also be realized in the filling panel 30.

Thus, both load-bearing functional elements 32—for example the profiled elements 44—and insulating functional elements 32 can be integrated into the filling panel 30 due to the structural foam 38 and/or the insulating material to be filled, as well as other functional elements 32, such as, for example, climate elements, air ducts, cable channels, wiring etc.

A possible assembly process for the fuselage panel 10 illustrated in FIG. 1 is explained in more detail below.

An assembly process preferably proceeds in such a manner that the outer shell 20, formed by the outer skin 28, is fabricated in such a way that positioning aids (not shown) for the preassembled filling panels 30 are already built in and corresponding preparations for the “fusion” of the outer skin 28 with the preassembled filling panels 30 are provided.

The outer skin 28 can consist, comprise or be configured, for example, from composite materials, such as, in particular, CFRP materials, or of metallic materials or of mixed forms (e.g. metal and CFRP).

In a parallel step, the inner panel 24 is fabricated, which preferably also bears positioning aids (not shown) and—as described above—has the corresponding properties for use as a cabin 14.

The preferably pre-assembled filling panels 30 are also fabricated and equipped accordingly with a system function. For example, cables, insulations, ventilation systems etc. can be already integrated into the filling panel 30 during its fabrication. These filling panels 30 are preferably to be constructed from composite materials, such as, in particular, CFRP or like composites, in order to avoid thermal bridges between the inner panel 24 and the outer skin 28.

Assembly now preferably takes place by an incorporated functional layer 46, 48. For example, a film of a material suitable for connecting the shells 18, 20 to the filling panel 30 by substance-to-substance connection is provided. Preferably, the functional layer 46, 48 is configured in such a way that a disengagement of the connection is possible by a special treatment. For example, the film is made from a hot-melting adhesive 52.

The functional layer 46, 48 makes a structural connection between the shells 18, 20 and the preassembled filling panel 30 possible.

For this purpose, the filling panel 30 is first connected to the outer skin 28 with a first functional layer 46. Now, an open sandwich structure is created, with the cavities 42 still being exposed.

The open sandwich structure makes it possible to continue to install systems in the fuselage. The open sandwich structure 54 is shown in FIG. 2.

In particular, the other functional elements 32 can now be introduced into the cavities 42, and thus the fuselage panel 10 can be completely equipped with functional elements 32. Thus, very different systems can be integrated into the fuselage panel 10.

If equipping is completed, the open sandwich structure 54 is sealed with the inner panel 24. This is also done with an assembly process based on a second functional layer 48, wherein the film 50 with the dissolvable adhesive 52 can also be used.

The connection-producing functional layer 46 can be used for dismantling or repair. If, for example, a hot-melting adhesive is used as the material for the film 50, the functional layer 46, 48 can be heated and detached. Thus, it is possible to reach the functional elements 32 integrated into the filling panel 30.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE NUMERALS

10 Fuselage panel
12 Fuselage structure
14 Cabin
16 Sandwich element
18 Inner shell
20 Outer shell
22 Core
24 Inner panel
26 Interior space delimitation
28 Outer skin
30 Filling panel
32 Functional element
34 Core material
36 Join surface
38 Structural foam
40 Protrusion
42 Cavity
44 Profiled element
46 First functional layer
48 Second functional layer
50 Film
52 Adhesive
54 Open sandwich structure

1. A production method for producing a load-bearing fuselage panel for a fuselage section of an aircraft fuselage in an area of an aircraft cabin, comprising:
manufacturing the fuselage panel to have a sandwich construction with an inner panel and an outer skin as shells and a filling panel embedded between the shells as a core, while
configuring the outer skin as a part of a fuselage structure and the outer delimitation of the aircraft fuselage,
configuring the inner panel for an interior space delimitation of the cabin, and
integrating functional elements of the fuselage structure and the cabin and/or the aircraft into the filling panel.

2. The production method according to claim 1, comprising steps of:
a) designing and fabricating the filling panel in such a way that it is configured for accommodating functional elements of the fuselage structure and of the cabin and/or of the aircraft,
b) providing the filling panel with functional elements of the fuselage structure and/or of the cabin and/or of the aircraft;
c) fabricating the outer skin as a shell of the fuselage panel,
d) fabricating the inner panel as a shell of the fuselage panel,
e) attaching the filling panel to one of the shells, and
f) attaching the other shell to the filling panel.

3. The production method according to claim 2, wherein:
step a) includes at least one, several or all of steps of:
a1) pre-assembling the filling panel,
a2) fabricating the filling panel from composite material or composite materials;
a3) fabricating the filling panel from profiled elements made from a flat material and filler material;
a4) providing the filling panel with a core material, in particular with a structural foam;
a5) providing the filling panel with protrusions and cavities;
a6) providing the filling panel with join surfaces, which are prepared for a substance-to-substance connection to at least one of the shells;
a7.1) fabricating the filling panel by RTM technology;
a7.2) fabricating the filling panel to have a fully thermoplastic composite construction; and/or
a8) fabricating the filling panel with omega profiles with a foam portion.

4. The production method according to claim 2 wherein:
step b) includes at least one, several or all of steps of:
b1) pre-mounting at least one functional element of the fuselage structure and/or of the cabin into the filling panel prior to the steps e) and f);
b2) inserting at least one functional element of the fuselage structure and/or of the cabin into the filling panel attached to the one fuselage component between the steps e) and f);
b3) providing the filling panel, during fabrication according to step a), with webs, formers, ribs and/or joints as functional elements for the load-bearing configuration of the fuselage structure;
b4) incorporation of at least one system component of a cabin system, a flight system and/or a fuselage structure system as a functional element into at least one cavity of the filling element; and/or
b5) inserting at least one functional element into at least one cavity of the filling element and filling the cavity with an insulating material and/or covering the cavity with a shell within the context of carrying out at least one of the steps e) and f).

5. The production method according claim 2, wherein:
step c) includes at least one, several or all of steps of:
c1) fabricating the outer skin from a metal material;
c2) fabricating the outer skin from a composite material, in particular a fiber composite material;
c3) fabricating the outer skin with a lightning protection device;
c4) fabricating the outer skin in such a way that requirements for the protection against damage of the aircraft are satisfied, particularly by equipping the outer skin with a damage, stress and/or fatigue monitoring device; and/or
c5) providing the outer skin with at least one positioning aid for positioning the filling panel on the outer skin.

6. The production method according claim 2, wherein:
step d) has one, several or all of steps of:
d1) fabricating the inner panel with predetermined fire protection properties;
d2) fabricating the inner panel in such a manner that fire protection requirements of the cabin are met;
d3) fabricating the inner panel in such a manner that it is suitable as an outer closure of the cabin towards the fuselage structure;
d4) fabricating the inner panel with at least one positioning aid for the relative positioning between the inner panel and the filling panel while carrying out the corresponding one of the steps e) or f).

7. The production method according claim 2, wherein
step e) includes one, several or all of steps of:
e1) relative positioning of the filling panel and the one shell by positioning aids prefabricated on the one shell;
e2) connecting the filling panel to the one shell by substance-to-substance connection;
e3) connecting the filling panel to the one shell while producing covalent bonds;
e4) arranging the filling panel with open cavities, so that an open sandwich structure for inserting functional elements into the filling panel is created;
e5) gluing the filling panel to the one shell at prepared join surfaces of the filling panel;
e6) detachably connecting the filling panel to the one shell;
e7) detachably attaching the filling panel to the one shell by a functional layer;
e8) detachably attaching the filling panel to the one shell by an adhesive that dissolves under a dissolving treatment; and/or
e9) attaching the filling panel at first only to the outer skin.

8. The production method according to claim 2, wherein:
step f) includes one, several or all of steps of:
f1) relative positioning of the filling panel and the other shell by positioning aids prefabricated on the other shell;
f2) connecting the filling panel to the other shell by substance-to-substance connection;
f3) connecting the filling panel to the other shell while producing covalent bonds;
f4) gluing the filling panel to the other shell at prepared join surfaces of the filling panel;
f5) detachably connecting the filling panel to the other shell;
f6) detachably attaching the filling panel to the other shell by another functional layer;
f7) detachably attaching the filling panel to the other shell by an adhesive that dissolves under a dissolving treatment; and/or
f8) attaching the inner panel to the filling element after the filling element has first been attached to the outer skin;
f9) sealing an open sandwich structure formed by cavities of the filling panel after at least one functional element has been introduced into the cavity.

9. A load-bearing fuselage panel for forming a fuselage section as a part of a load-bearing structure of an aircraft fuselage in the area of an aircraft cabin, wherein the fuselage panel is formed to have a sandwich construction with an inner panel and an outer skin as shells and a filling panel embedded between the shells as a core,
wherein the outer skin is configured as a part of a fuselage structure and the outer delimitation of the aircraft fuselage,
wherein the inner panel is configured for an interior space delimitation of the cabin, and wherein functional elements of the fuselage structure and the cabin or the aircraft are integrated into the filling panel.

10. The fuselage panel according to claim 9, obtained by a method according to claim 1.

11. An aircraft fuselage or aircraft cabin, comprising a fuselage panel according to claim 9.
